(19) United States
(12) Patent Application Publication
(10) Pub. No.: US 2018/0159815 A1
(43) Pub. Date: Jun. 7, 2018

(54) SELECTIVELY EXTENDING LIFE OF PREFETCHED CONTENT FOR DOMAIN NAME SYSTEM CONTENT DELIVERY

(71) Applicant: Nominum, Inc., Redwood City, CA (US)

(72) Inventors: Robert Thomas Halley, Redwood City, CA (US); Brian Wellington, Fremont, CA (US)

(21) Appl. No.: 15/830,472

(22) Filed: Dec. 4, 2017

Related U.S. Application Data
(60) Provisional application No. 62/430,288, filed on Dec. 5, 2016.

(51) Int. Cl. H04L 29/12; H04L 29/08

(52) U.S. Cl. CPC H04L 61/1511; H04L 67/2847; H04L 61/3025; H04L 61/2076; H04L 61/6009

(57) ABSTRACT

A method for selectively extending a life of prefetched content for DNS content delivery is disclosed. The method includes providing a cache to keep at least one DNS entry. The DNS entry includes a domain name and a DNS answer associated with the domain name. The DNS entry is assigned a lifetime. The method includes determining that a DNS query is received, wherein the DNS query includes a further domain name matching the domain name of the DNS entry. The method further includes determining that the lifetime of the DNS entry is to expire within a pre-determined interval. In response to the determination, the method allows sending the DNS query to an authoritative DNS to obtain a further DNS answer associated with the domain name. If the further DNS answer is not received, the method generates a copy of the DNS entry with a shorter lifetime.

### CROSS-REFERENCE TO RELATED APPLICATIONS

This application claims the benefit of U.S. Provisional Application No. 62/430,288, filed Dec. 5, 2016. The subject matter of the aforementioned application is incorporated herein by reference for all purposes.

### TECHNICAL FIELD

This disclosure relates to processing Domain Name System (DNS) data. More specifically, this disclosure relates to systems and methods for improving DNS content delivery.

### BACKGROUND

In computer networking, domain names help in identifying locations where certain information or services can be located on a public or private network. Domain names are typically formed according to rules and procedures of the DNS. Domain names can be used for various naming and addressing purposes. In general, a domain name can be resolved to an Internet Protocol (IP) address of a resource, such as a personal computer (PC), a server hosting website pages, or a website page or service. Thus, the DNS allows translating domain names (such as “www.example.com”) into the corresponding IP address (such as “123.4.56.78”) needed to establish Transmission Control Protocol/Internet Protocol (TCP/IP) communication over the Internet.

There are two roles a DNS server may fill in the DNS system: an authoritative server or a recursive server; sometimes the latter is called a “caching server”. The authoritative server may have complete official information about part of the DNS namespace. The authoritative server's scope of authority is made up of multiple “zones”. A zone may include everything at or below a specified name in the DNS namespace, minus DNS content beneath the specified name that has been delegated by the authoritative server to other authorities. A recursive server uses the protocol described by the DNS standard to find the proper authorities for a query, and obtain the response to the query from them. Some servers work in both roles, and others only do one of the roles.

When a DNS recursive server receives a query from a client, the DNS recursive server checks whether the DNS query can be answered based on local information of the DNS server. If the queried domain name and queried type matches a corresponding resource record set (RR set) in a local cache, and the cached data has not expired, then the DNS server can answer. If no local record exists for the queried domain name and type, or if it has expired, the DNS recursive server will use the DNS protocol to find the proper authorities and obtain the response from them.

In order to avoid exposing the client query to the delays associated with communicating with the proper authorities when a cache entry has expired, some DNS recursive servers will proactively re-resolve content before it expires. This is called “prefetching”. For example, a query by a client for www.nominum.com type AAAA near the end of the lifetime of the cached record will not only return the response immediately to the client, but will also cause a background recursion for www.nominum.com type AAAA. If this recursion is successful, the cache entry will be refreshed with the latest information, and subsequent client queries will again get a fast cache hit instead of a slow cache miss. Prefetching may be done for all records or only for some. It may be done by an automated maintenance process, or it may be triggered by some event, e.g. a client querying for the record near the end of its life.

Distributed Denial of Service (DoS) attacks against authoritative DNS servers have been increasing. The DoS attacks, especially when coming from Internet of Things (IoT) devices, may not be easily and quickly mitigated by authoritative DNS server operators. If all the authoritative DNS servers for a service are under DoS attacks, then the service becomes unavailable. If an authoritative service is authoritative for many zones, e.g. a content delivery network (CDN), then the impact from an attack on an authority can affect many parts of the DNS namespace at the same time.

One way of solving the problem with attacks is preserving the contents of recursive DNS server's caches beyond their natural DNS time-to-live (TTL), as it is likely that the last-known-good values can still provide an answer to a query. Simple solutions to preserve cache content (for example, “just ignore the TTL” or imposing minimum TTL values) are not optimal, as they violate DNS norms when the service is not under attack or broken, and may impair the correct operation of CDNs. In addition, not all DNS content is equally worth preserving, due to the “long tail” aspect of DNS queries.

What is needed is to preserve popular content and ensure that when the authorities became available again, content would be rapidly updated to the current values from authoritative servers.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Generally, the present disclosure is directed to the technology for processing DNS data. Some embodiments of the present disclosure may facilitate providing DNS answers to DNS queries by DNS recursive servers.

According to one example embodiment of the present disclosure, a method for selectively extending a life of prefetched content for DNS content delivery is provided. The method may include providing a cache to keep at least one DNS entry. The at least one DNS entry can include a domain name and a DNS answer associated with the domain name. The at least one DNS entry can be assigned a first lifetime. The method can further include determining that a DNS query is received, wherein the DNS query includes at least a further domain name and the further domain name matches the domain name of the at least one DNS entry. The method also includes determining that the first lifetime of the at least one DNS entry is scheduled to expire within a pre-determined interval.

In response to the determination, the method can proceed with sending the DNS query to an authoritative DNS to obtain at least a further DNS answer associated with the domain name. The method can further include determining that the further DNS answer is not received. If the further DNS answer is not received, the method can proceed with generating a further DNS entry. The further DNS entry can include a copy of the at least one DNS entry. The method can also include assigning a second lifetime to the further DNS entry, the second lifetime being shorter time than the first lifetime.

In some embodiments, the DNS answer includes a resource record set of one of a type A or a type AAAA. The pre-determined interval can be 1/16 of the first lifetime or at least 30 seconds. The method can further include marking the further DNS entry as “extension”.

In some embodiments, the method further includes determining that a new DNS query is received from a client during the second lifetime, the new DNS query includes a new domain name matching the further domain name. The method can further include determining that the second lifetime of the further DNS entry is expired within a further pre-determined interval. In response to the determination that the new DNS query is received, and the second lifetime is to expire within the further pre-determined interval, the method can proceed with repeating the generation of the further DNS entry and assigning the second lifetime to the further DNS entry. The further predetermined interval can be, for example, 2 seconds.

In certain embodiments, the method includes generating, based on the further DNS entry, a new DNS answer and sending the new DNS answer to the client. Prior to sending the new DNS answer to the client, the method can set a time-to-live parameter for the at least one DNS answer to zero.

In some embodiments, the method also includes determining that the further DNS answer is received. In response to receiving the further DNS answer, the method can generate a new DNS entry including the domain name and the further DNS answer. The method can also include assigning the first lifetime to the new DNS entry.

According to another example embodiment of the present disclosure, a system for selectively extending a life of prefetched content for DNS content delivery is provided. The system may include at least one processor and a memory storing processor-executable codes, wherein the at least one processor can be configured to implement the operations of the above-mentioned method for selectively extending life of prefetched content for DNS content delivery upon execution of the processor-executable codes.

According to another example embodiment of the present disclosure, the operations of the above-mentioned method for selectively extending life of prefetched content for DNS content delivery are stored on a machine-readable medium comprising instructions, which when implemented by one or more processors perform the recited operations.

Other example embodiments of the disclosure and aspects will become apparent from the following description taken in conjunction with the following drawings.

### BRIEF DESCRIPTION OF DRAWINGS

Example embodiments are illustrated by way of example and not limitation in the figures of the accompanying drawings, in which like references indicate similar elements.

FIG. 1 is a block diagram of an example computer network environment suitable for practicing the methods for selectively extending a life of prefetched content for DNS content delivery as described herein.

FIG. 2 is a block diagram showing an example data cache.

FIG. 3 is a flow chart of an example method for selectively extending life of prefetched content for DNS content delivery.

FIG. 4 is a computer system that may be used to implement methods for selectively extending life of prefetched content for DNS content delivery.

### DETAILED DESCRIPTION OF EXAMPLARY EMBODIMENTS

The technology disclosed herein is concerned with methods for improving DNS content delivery. Embodiments of the present disclosure may extend the life of popular content in a cache of a DNS when an updating of cache entries fails.

For purposes of this patent document, it is important to provide definitions of certain additional terminology as used herein. The terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

The term “DNS” has its ordinary meaning of Domain Name System, which represents a hierarchical distributed naming system for computers, servers, content, services, or any resource available via the Internet or a private network. The terms “domain” and “domain name” are given their ordinary meaning such as a network address to identify the location of a particular host, web resource, file, content, service, computer, server, and so forth. Each domain name can be made up of a series of character strings separated by dots. The right-most label in a domain name is known as the “top-level domain,” such as “.com,” “.org,” and the like. Each top-level domain supports second-level domains, such as the “nominum” level in “www.nominum.com.” Each second-level domain can include some third-level domains located immediately to the left of the second-level domain (e.g., the “www” level in “www.nominum.com”). There can be additional level domains as well, with virtually no limitation. For example, a domain with additional domain levels could be “www.photos.nominum.com.”

The present disclosure is directed to a technology for processing DNS data. Some embodiments of the present disclosure can facilitate providing DNS answers to DNS queries by DNS recursive servers. According to an example embodiment of the present disclosure, a method for selectively extending life of prefetched content for DNS content delivery is provided. The method can include providing a cache to keep at least one DNS entry. The at least one DNS entry can include a domain name and a DNS answer associated with the domain name. The at least one DNS entry can be assigned a first lifetime. The method may further include determining that 1) a DNS query is received, wherein the DNS query includes at least a further domain name and the further domain name matches the domain name of the at least one DNS entry; and 2) the first lifetime of the at least one DNS entry is scheduled to expire within a pre-determined interval. In response to the determination, the method can proceed with sending the DNS query to an authoritative DNS in order to obtain a further DNS answer associated with the domain name. If the further DNS answer is not received, the method can proceed with generating a further DNS entry. The further DNS entry can be a copy of the at least one DNS entry. The method can further include assigning a second lifetime to the further DNS entry. The second lifetime can be a shorter time than the first lifetime.

Referring now to the drawings, various embodiments are described in which like reference numerals represent like parts and assemblies throughout the several views. It should be noted that the reference to various embodiments does not limit the scope of the claims attached hereto. Additionally, any examples outlined in this specification are not intended to be limiting and merely set forth some of the many possible embodiments for the appended claims.

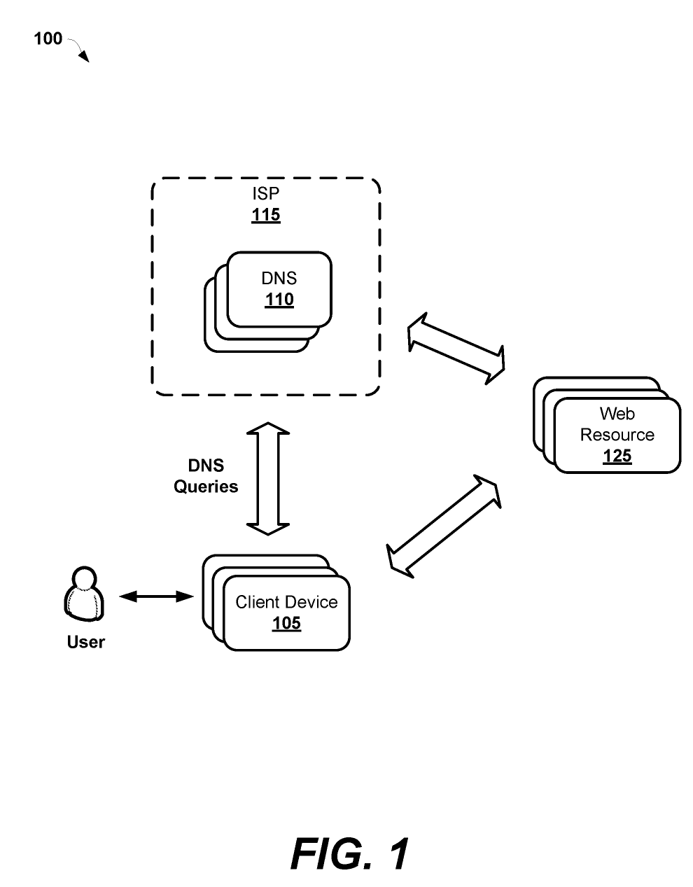

FIG. 1 shows a block diagram of an example computer network environment 100 suitable for practicing the methods described herein. It should be noted, however, that the environment 100 is just one example and is a simplified embodiment provided for illustrative purposes, and reasonable deviations of this embodiment are possible as will be evident for those skilled in the art.

As shown in FIG. 1, there is provided a client device 105 (also referred to herein as “client” for simplicity). The client device 105 can include any appropriate computing device having network functionalities allowing communicating using any existing IP protocols (e.g., IPv4, IPv6). To this end, each client device 105 can be associated with an IP address. Some examples of the client device 105 include, but are not limited to, a computer (e.g., laptop computer, tablet computer, desktop computer), server, cellular phone, smart phone, gaming console, multimedia system, smart television device, set-top box, infotainment system, in-vehicle computing device, informational kiosk, robot, smart home computer, home appliance device, IoT device, Internet of Things (IoE) device, sensor, thermostat, software application, computer operating system, modem, router, and so forth. The environment 100 can, in some embodiments, include multiple client devices 105. For the purposes of this document, the client devices 105 are used by users for Internet browsing purposes. Particularly, the users can open a web browser installed on the client device 105 and control it to reach any website page.

When the user operates the client device 105, the client device 105 can make certain client inquires to the computer network environment 100, such as a request to open, in a web browser, a website hosted by a web resource 125, download a file from the web resource 125, and so forth. A client inquiry may include a DNS query associated with a domain name (e.g., in the form of “www.nominum.com”), which requires the resolution by a DNS server into one or more corresponding IP addresses associated with the web resource 125. The DNS query initiated by the client device 105 can be transmitted to a recursive DNS server, or simply, DNS 110, which can be associated with a particular Internet Service Provider (ISP) 115. The ISP 115 can include a plurality of DNS recursive servers 110. For purposes of this patent document, the terms “DNS query,” “DNS inquiry,” and “DNS request” may mean the same and, therefore, can be used interchangeably.

The DNS 110 can resolve the DNS query and return an IP address associated with the domain name of the DNS query. The IP address can be delivered to the client device 105. In certain embodiments, the DNS query includes the following data: an IP address of the client 105, a time stamp of the DNS inquiry, DNS query name (e.g., a domain name), and/or a DNS query type.

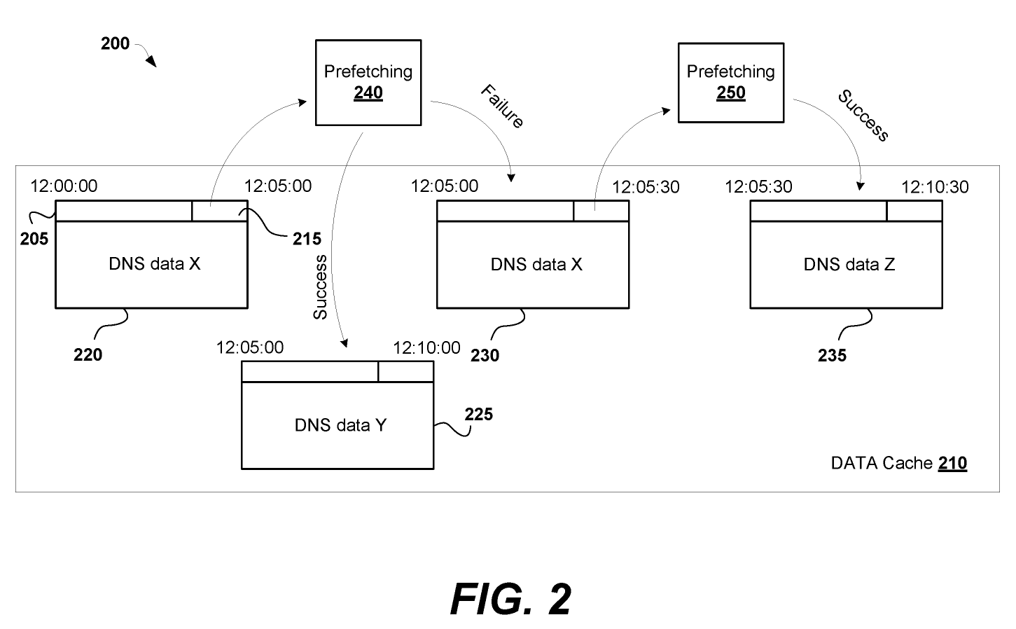

FIG. 2 is a block diagram 200 showing an example data cache 210 (also referred to herein and identified in the example in FIG. 2 as DATA cache 210). In some embodiments, the data cache 210 can be associated with DNS 110. The data cache 210 can keep at least one DNS entry representing popular DNS content. In some embodiments, the DNS entry includes an IP address, a domain name, and a type and a resource record (RR) set. The data cache 210 can store DNS entries associated with IP addresses of the most requested domain names received by the recursive DNS 110 for resolving. When the recursive DNS 110 receives a DNS query from the client device 105, the recursive DNS 110 looks first at the data cache 210 for an answer to the DNS query. If the data cache 210 already contains a DNS entry with the answer to the DNS query, the DNS 110 may use the DNS entry to return the answer to the client device 105. If no DNS entry containing the answer to the DNS query is found in the data cache 210, the recursive DNS 110 may pass the DNS query to further DNSs (for example, an authoritative DNS (also referred to as an authority) to resolve the DNS query, receive the answer, and resend the answer to the client device 105).

As shown in FIG. 2, an example DNS entry 220 can be associated with a lifetime 205. In various embodiments, each DNS entry in a data cache is immutable. In various embodiments, the DNS entry 220 is not used to answer queries from the DATA cache 210 once the lifetime 205 is expired. The DNS entry 220 can trigger prefetching 240 if another DNS query, for which the DNS entry 220 contains the answer, arrives in the recursive DNS 110 within a specified interval 215 representing the last part of the lifetime 205. The prefetching 240 can include the process of refreshing the answer to DNS query from an authoritative DNS. In some embodiments, the specified interval 215 of the lifetime 205 of the DNS entry is selected as the last 1/16 part of the lifetime 205 of the DNS entry. Upon detecting that the DNS query arrived within the specified interval 215, the recursive DNS 110 can resolve the query and request and receive a refreshed answer to the DNS query from the authoritative DNS. The refreshed answer can include a refreshed RR set for the domain name of the DNS query. After receiving the refreshed answer from the authoritative DNS, the recursive DNS 110 is configured to add a new DNS entry 225 to the data cache 210. The new DNS entry 225 contains the refreshed answer to the DNS query. The DNS entry 225 can be then assigned a new lifetime. The new DNS entry 225 will replace the DNS entry 220 to keep the answer to the same DNS query when the DNS entry 220 expires.

In some embodiments, if the lifetime 205 of the DNS entry 210 enters the specified interval 215 (for example, last 1/16 of the lifetime) and prefetching 240 is in an active state, the recursive DNS 110 is configured to add an extension DNS entry 230 to the DATA cache 210. The extension DNS entry 230 can be added when prefetching 240 fails. The extension DNS entry 230 includes the same DNS data as in the DNS entry 210. The extension DNS entry 230 can be marked as “extension.” The extension DNS entry 230 can be assigned a lifetime shorter than the lifetime of the DNS entry 220. For example, the lifetime of the extension DNS entry 230 can be set to 30 seconds. The purpose of adding the extension DNS entry 230 is to replace the DNS entry 220 and to allow keeping an answer to a DNS query in DATA cache 210 for a short time while waiting for the authoritative (authority) DNS to answer. In some embodiments, the DNS entry 220 can be extended immediately when only 2 seconds of lifetime of the DNS entry 220 is left and prefetching 240 is still running. When a DNS query is received by DNS 110 and DNS 110 uses the extended DNS entry 230 to form and send DNS data to client device 105, the TTL field of the sent DNS data can be rendered as 0.

In some embodiments, further prefetching 250 can be executed for the extension DNS entry 230 when the lifetime of the extension DNS entry 230 is about to expire in a way similar to how prefetching 240 is executed for the DNS entry 220. The extension DNS entry 230 may be replaced by a further extension DNS entry if the authoritative server fails to provide refreshed DNS data. When and if the authoritative (authority) server answers with refreshed DNS data, the extension DNS entry 230 can be replaced by a regular DNS entry 235 with a regular lifetime. Overall, further extension of DNS entry may be terminated due to two reasons: 1) the prefetching succeeds; or 2) no new DNS query comes to DNS 110, which would require receipt of DNS data from the extension DNS entry. For example, if DNS query does not arrive in the last 1/16 of the lifetime of an extension DNS entry, the extension process ends. The lifetime of the extension DNS entry 230 is chosen to be short enough to have a fresher DNS data when extension DNS entry is replaced by a regular DNS entry upon success of prefetching, so that a refreshed answer to DNS query is available.

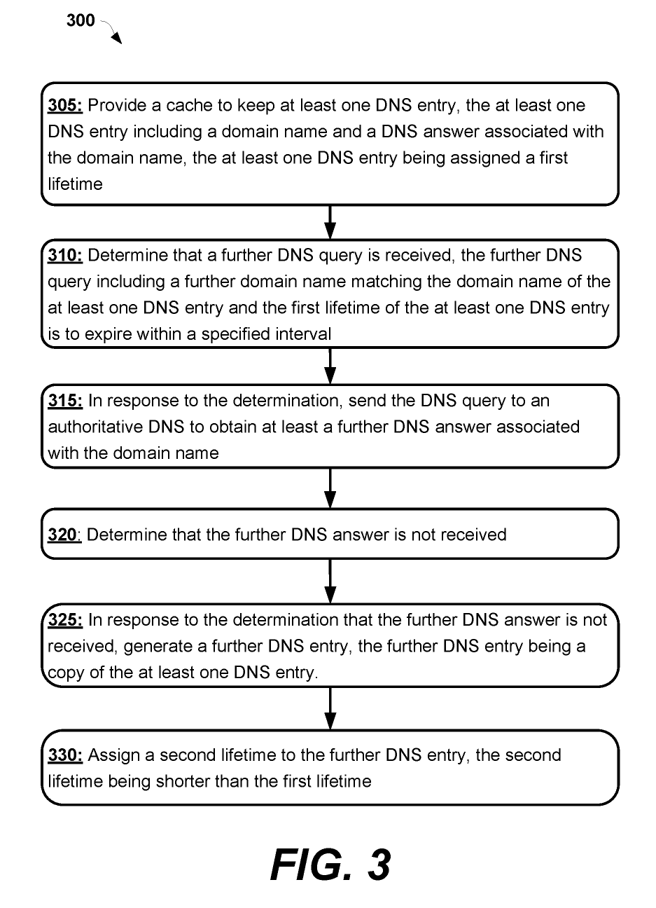

FIG. 3 is a flow chart of an example method 300 for improving DNS content delivery, according to some embodiments. The method 300 for improving DNS content delivery may be performed by processing logic that may comprise hardware (e.g., decision-making logic, dedicated logic, programmable logic, and microcode), software (such as software run on a general-purpose computer system or a dedicated machine), or a combination of both. In one example embodiment, the processing logic refers to one or more components of the recursive DNS 110 described above with reference to FIG. 1. Notably, the steps recited below may be implemented in an order different than described and shown in the FIG. 3. Moreover, the method 300 may have additional steps not shown herein, but which can be evident to those skilled in the art from the present disclosure. The method 300 may also have fewer steps than outlined below and shown in FIG. 2.

In block 305, the method 300 can commence with providing a cache to keep at least one DNS entry. The DNS entry may include a domain name and a DNS answer associated with the domain name. For example, the DNS answer can include a type and a RR set. The DNS entry can be assigned a first lifetime, during which the DNS entry is kept in the cache.

In block 310, the method 300 can proceed with determining that 1) a DNS query is received. The DNS query can include at least a further domain name matching the domain name of the at least one DNS entry; and 2) the first lifetime of the at least one DNS entry is scheduled to expire within a pre-determined interval.

In block 315, in response to the determination made in the block 310, the method 300 can proceed with sending the DNS query to an authoritative DNS to obtain at least a further DNS answer associated with the domain name.

In block 320, the method 300 may proceed with determining that the further DNS answer is not received.

In block 325, in response to the determination that the further DNS answer is not received, the method 300 can proceed with generating a further DNS entry. The further DNS entry can be a copy of at the least one DNS entry.

In the block 330, the method 300 can include assigning a second lifetime to the further DNS entry. The second lifetime is a shorter time than the first lifetime.

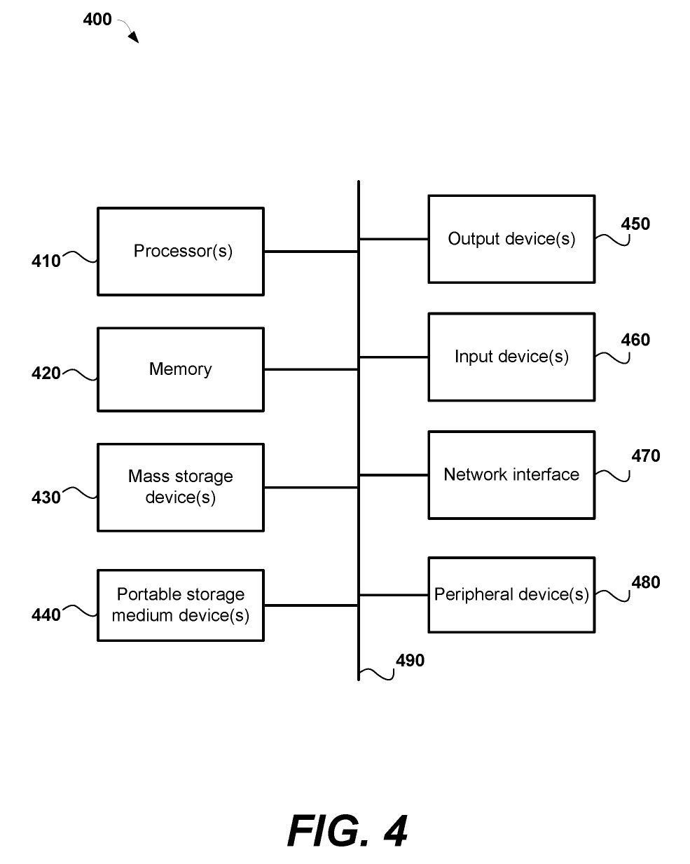

FIG. 4 illustrates an example computer system 400 that may be used to implement various embodiments described herein. The system 400 may be implemented in the context of the likes of client device 105, the DNS server 110, and web resource 125. The computing system 400 may include one or more processor(s) 410 and memory 420. Memory 420 stores, in part, instructions and data for execution by processor(s) 410. Memory 420 can store the executable code when the system 400 is in operation. The system 400 may further include one or more mass storage device(s) 430, one or more portable storage medium device(s) 440, one or more output device(s) 450, one or more input device(s) 460, a network interface 470, and one or more peripheral device(s) 480.

The components shown in FIG. 4 are depicted as being connected via a single bus 490. The components may be connected through one or more data transport means. Processor(s) 410 and memory 420 may be connected via a local microprocessor bus, and the mass storage device(s) 430, peripheral device(s) 480, portable storage medium device(s) 440, and network interface 470 may be connected via one or more input/output (I/O) buses.

Mass storage device(s) 430, which may be implemented with a magnetic disk drive or an optical disk drive, is a non-volatile storage device for storing data and instructions for use by a magnetic disk or an optical disk drive, which in turn may be used by processor(s) 410. Mass storage device(s) 430 can store the system software for implementing embodiments described herein for purposes of loading that software into memory 420.

Portable storage medium drive(s) 440 can operate in conjunction with a portable non-volatile storage medium, such as a compact disk (CD) or digital video disc (DVD), to input and output data and code to and from the computer system 400. The system software for implementing embodiments described herein may be stored on such a portable medium and input to the computer system 400 via the portable storage medium drive(s) 440.

Input device(s) 460 provide a portion of a user interface. Input device(s) 460 may include an alphanumeric keypad, such as a keyboard, for inputting alphanumeric and other information, or a pointing device, such as a mouse, a trackball, a stylus, or cursor direction keys. Additionally, the computer system 400 as shown in FIG. 4 includes output device(s) 450. Suitable output device(s) include speakers, printers, network interfaces, and monitors.

Network interface 470 can be utilized to communicate with external devices, external computing devices, servers, and networked systems via one or more communications networks such as one or more wired, wireless, or optical networks including, for example, the Internet, intranet, local area network (LAN), wide area network (WAN), cellular phone networks (e.g. Global System for Mobile (GSM) communications network, packet switching communications network, circuit-switching communications network), Bluetooth radio, and an IEEE 802.11-based radio frequency network, among others. Network interface 470 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a Universal Serial Bus (USB).

Peripheral device(s) 480 may include any computer support device to add additional functionality to the computer system. Peripheral device(s) 480 may include a modem or a router. Peripheral device(s) 480 may also include input and output devices.

The components contained in the computer system 400 are those typically found in computer systems that may be suitable for use with embodiments described herein and are intended to represent a broad category of such computer components that are well known in the art. Thus, the computer system 400 can be a PC, handheld computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, TIZEN and other suitable operating systems.

Some of the above-described functions may be composed of instructions that are stored on storage media (e.g., computer-readable medium). The instructions may be retrieved and executed by the processor(s). Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a Central Processing Unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire, and fiber optics, among others, including the wires that include one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Thus, methods and systems for improving DNS content delivery have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense. There are many alternative ways of implementing the present technology. The disclosed examples are illustrative and not restrictive.

What is claimed is:

1. A computer-implemented method for domain name system (DNS) content delivery, the method comprising:
providing a cache to keep at least one DNS entry, the at least one DNS entry including a domain name and a DNS answer associated with the domain name, the at least one DNS entry being assigned a first lifetime;
determining that:
a DNS query is received, the DNS query including at least a further domain name, the further domain name matching the domain name of the at least one DNS entry; and
the first lifetime of the at least one DNS entry is scheduled to expire within a pre-determined interval; and
in response to the determination:
sending the DNS query to an authoritative DNS to obtain at least a further DNS answer associated with the domain name;
determining that the further DNS answer is not received; and
in response to the further DNS answer not being received:
generating a further DNS entry, the further DNS entry being a copy of the at least one DNS entry; and
assigning a second lifetime to the further DNS entry, the second lifetime being shorter than the first lifetime.

2. The computer-implemented method of claim 1, wherein the DNS answer includes a resource record set of one of a type A or a type AAAA.

3. The computer-implemented method of claim 1, wherein the pre-determined interval is 1/16 of the first lifetime.

4. The computer-implemented method of claim 1, wherein the second lifetime is at least 30 seconds.

5. The computer-implemented method of claim 1, further comprising marking the further DNS entry as an extension.

6. The computer-implemented method of claim 1, further comprising:
determining that:
a new DNS query is received from a client during the second lifetime, and the new DNS query including a new domain name and the new domain name matching the further domain name; and
the second lifetime of the further DNS entry has expired within a further pre-determined interval; and
in response to the determination that the new DNS query has been received and the second lifetime has expired within the further pre-determined interval, repeating the generation of the further DNS entry and assigning the second lifetime to the further DNS entry.

7. The computer-implemented method of claim 6, wherein the further pre-determined interval is 2 seconds.

8. The computer-implemented method of claim 6, further comprising:
generating, based on the further DNS entry, a new DNS answer; and
sending the new DNS answer to the client.

9. The computer-implemented method of claim 8, further comprising, prior to sending the new DNS answer to the client, assigning a time-to-live parameter of the at least one DNS answer to zero.

10. The computer-implemented method of claim 1, further comprising:
determining that the further DNS answer is received; and
in response to the determination that the further DNS answer is received:
generating a new DNS entry, the new DNS entry including the domain name and the further DNS answer; and
assigning the first lifetime to the new DNS entry.

11. A system for domain name system (DNS) content delivery, the system comprising:
at least one processor; and
a memory communicatively coupled with the at least one processor, the memory storing instructions, which when executed by the at least one processor perform a method comprising:
providing a cache to keep at least one DNS entry, the at least one DNS entry including a domain name and a DNS answer associated with the domain name, the at least one DNS entry being assigned a first lifetime;
determining that:
a DNS query is received, the DNS query including at least a further domain name, the further domain name matching the domain name of the at least one DNS entry; and
the first lifetime of the at least one DNS entry is scheduled to expire within a pre-determined interval; and
in response to the determination:
sending the DNS query to an authoritative DNS to obtain at least a further DNS answer associated with the domain name;
determining that the further DNS answer is not received; and
in response to the further DNS answer not being received:
generating a further DNS entry, the further DNS entry being a copy of the at least one DNS entry; and
assigning a second lifetime to the further DNS entry, the second lifetime being shorter than the first lifetime.

12. The system of claim 11, wherein the DNS answer includes a resource record set of one of a type A or a type AAAA.

13. The system of claim 11, wherein the pre-determined interval is 1/16 of the first lifetime.

14. The system of claim of claim 11, wherein the second lifetime is at least 30 seconds.

15. The system of claim 11, wherein the method further comprises:
determining that:
a new DNS query is received from a client during the second lifetime, and the new DNS query including a new domain name, the new domain name matching the further domain name; and
the second lifetime of the further DNS entry has expired within a further pre-determined interval; and
in response to the determination that the new DNS query has been received and the second lifetime has expired within the further pre-determined interval, repeating the generation of the further DNS entry and assigning the second lifetime to the further DNS entry.

16. The system of claim 15, wherein the further pre-determined interval is 2 seconds.

17. The system of claim 15, wherein the method further comprises:
generating, based on the further DNS entry, a new DNS answer; and
sending the new DNS answer to the client.

18. The system of claim 15, wherein the method further comprises, prior to sending the new DNS answer to the client, assigning a time-to-live parameter of the at least one DNS answer to zero.

19. The system of claim 15, wherein the method further comprises:
determining that the further DNS answer is received; and
in response to the determination that the further DNS answer is received,
generating a new DNS entry, the new DNS entry including the domain name and the further DNS answer; and
assigning the first lifetime to the new DNS entry.

20. A non-transitory computer-readable storage medium having embodied thereon instructions, which when executed by at least one processor, perform steps of a method, the method comprising:
providing a cache to keep at least one DNS entry, the at least one DNS entry including a domain name and a DNS answer associated with the domain name, the at least one DNS entry being assigned a first lifetime;
determining that:
a DNS query is received, the DNS query including at least a further domain name matching the domain name of the at least one DNS entry; and
the first lifetime of the at least one DNS entry is scheduled to expire within a pre-determined interval; and
in response to the determination:
sending the DNS query to an authoritative DNS to obtain at least a further DNS answer associated with the domain name;
determining that the further DNS answer is not received; and
in response to the determination that the further DNS answer is not received:
generating a further DNS entry, the further DNS entry being a copy of the at least one DNS entry; and
assigning a second lifetime to the further DNS entry, the second lifetime being a shorter time than the first lifetime.
